(19) United States
(12) Patent Application Publication
(10) Pub. No.: US 2024/0015299 A1
(43) Pub. Date: Jan. 11, 2024

(54) METHOD AND IMAGE PROCESSOR UNIT FOR PROCESSING IMAGE DATA OF AN IMAGE SENSOR

(71) Applicant: Dream CHIP Technologies GmbH, Garbsen (DE)

(72) Inventors: Fritz LEBOWSKY, St. Martin d'Uriage (FR); Martin FIEDLER, Hannover (DE)

(73) Assignee: Dream CHIP Technologies GmbH, Garbsen (DE)

(21) Appl. No.: 18/019,378

(22) PCT Filed: Feb. 3, 2022
(86) PCT No.: PCT/EP2022/052563

§ 371 Date: Feb. 2, 2023

(51) Int. Cl. H04N 19/137; H04N 19/182; H04N 19/46

(52) U.S. Cl. CPC H04N 19/137; H04N 19/182; H04N 19/46

(57) ABSTRACT

A method for processing of image data is described, wherein an image comprises a matrix of pixels. The method includes:
determining differences between a pixel value of a current pixel and a pixel value of a respective adjacent pixel in a number of gradient directions; and
encoding the current pixel by replacing the current pixel by the gradient direction having the minimum gradient difference for the current pixel.

Thus, the gradient direction is explicitly encoded into the output image data stream.

### FIELD OF THE INVENTION

The invention relates to a method for processing of image data, wherein an image comprises a matrix of pixel.

The invention further relates to an image processor unit for processing image data of an image sensor, that image sensor comprises a sensor area of a pixel matrix providing an image comprising matrix of pixel data.

Further, the invention relates to a computer program arranged to carry out the above referenced method.

### BACKGROUND OF THE INVENTION

In order to process image data from an image sensor connected to a controller, the image data must be transmitted with high-speed processes limited hardware resources. For example, when multiple cameras in an automotive application are connected to a central controller, a connection via high-speed serial link that has limited bandwidth is available. It is desirable to reduce the data rate on the link while safeguarding a high image quality.

A simple quantisation, i.e. reducing the bit depth of the image data, is trivial to implement, but will result in a visible degradation of image quality.

A transform-based encoding (e.g. JPEG, MPEG) provides a good image quality, but is very complex to implement and hard to keep the bitrate steady.

Wavelet encoding (e.g. JPEG2000 or similar) is a transform-based encoding requiring frame buffer. This causes delays which could be critical in specific applications like automotive applications.

Block encoding (e.g. bc7 format used for GPU texturing) provides a good image quality and a fixed bitrate. It is a relatively simple decoding procedure. However, the encoding is extremely hard and complex.

F. Lebowsky, M. Bona: Extraordinary Perceptual Colour Stability in Low Cost, Realtime Color Image Compression Inspired by Structure Tensor Analysis describes a non-linear method applied to image compression, wherein error quantities are being processed in several complementary differential domains enabling advanced visual masking strategies. A structure quantity and a magnitude quantity is estimated for each pixel in the image by sequential raster scan order, column after column, from top left to bottom right across the entire image. Across all local neighbours of a centre pixel, the minimum gradient magnitude is determined together with its maximum gradient magnitude in perpendicular direction. The minimum gradient magnitude is normalised by the sum of minimum gradient magnitude and maximum gradient magnitude. Structure quantities are classified in normalised gradient domain into three major categories, namely contours (triactories), zones (homogenous regions), and extremes (local minimum or maximum). For each class, an integral error control loop is operated and the major categories are prioritised in the order given by contours, zones and extremes.

U.S. Pat. No. 8,958,635 B2 discloses a method and device for processing a digital image, wherein each pixel has at least one colorimetric component. The value of the corresponding colorimetric component is modified so as to obtain a modified value situated inside or outside a colorimetric range associated with the corresponding colorimetric component. Therefore, by assigning a unique reference value that is situated in the colorimetric range and that is different from the limits to the modified values of the image that are situated outside the colorimetric space, the user can view the violations of the colorimetric space.

### SUMMARY OF THE INVENTION

The present invention provides an improved method for processing of image data, an improved image processor unit and a computer program for processing image data of an image sensor.

According to one embodiment, the method comprises the steps of:
a) determining the gradient differences between a current pixel value and the pixel value of a respective adjacent pixel in a number of gradient directions, and
b) encoding the current pixel by replacing the current pixel by the gradient directions having the minimum gradient difference determined in step a) for the current pixel.

Accordingly, the image processor unit is arranged to perform these steps a) and b), e.g. by hardware implementation into an image data processor, e.g. FPGA, or by a suitable computer program comprising instructions to perform the above steps on pixel data or a pixel data stream by use of a data processor.

According to the present invention, the gradient direction is explicitly coded into the output data stream.

The method provides the good image quality and can easily result in visually lossless image processing. The method requires a minimal amount of computation resources. There is no need of frame buffers. It requires a minimal amount of line buffers and minimal amount of processing capacity. The result is predictable and ideally is able to provide a fixed data rate. The compression ratio can be selected as desired.

A delta flag can be included to the gradient direction, which is used in step b) for encoding the current pixel in order to indicate that the pixel data reflects a predictor for the current pixel. Thus, the use of a delta flag allows to provide original pixel data and alternatively with indication by the delta flag predictor data.

The current pixel can be encoded by replacing the current pixel by the gradient direction. The gradient direction includes the data corresponding to the minimum gradient difference which is determined in step a), and including the encoded values for the gradient differences determined in step a) for the current pixel in case that the minimum gradient difference for the current pixel exceeds a threshold value.

Thus, the gradient direction is either provided at the output as determined in case that the difference between the predictions at the current pixels does not exceed a certain threshold. Otherwise, if the difference exceeds a certain threshold, so that the bit length of the value for the gradient difference requires a higher number of bits, the bits used for the gradient difference is reduced by further encoding the gradient difference value, i.e. the delta vector. This allows to provide the pixel data at the output with a certain bit length.

The method can be performed for each pixel in the matrix of an image considered as a current pixel to be compared with a set of surrounding pixels. For example, the image can consist of a rectangular grid of pixels. An image can be formed as greyscale with a single matrix, i.e. singlets of pixel, or a higher order image, e.g. colour-coded image comprising triplets of pixel in either the RGB or YUV colour space with (typically) e.g. 8 bits per component. The image can be encoded and decoded as a stream of pixels in normal English reading order, i.e. left-to-right and top-to-bottom.

The method can be performed for exactly one current pixel in a group of a number N of adjacent pixels. Thus, each run of N consecutive pixels forms a group, wherein groups do not overlap. The group size N is an encoding quality parameter. Only for one of the pixels in a group, a gradient difference (delta or “update”) is encoded. An index of that pixel within the group (update selector-index) can be encoded as ceil (log₂(N)) bit value.

Encoding the values for the gradient difference can be performed by assigning the values to predetermine codes of a code table. For example, the gradient difference i.e. the delta code can use a non-linear quantisation. The delta code can exploit two's complement wrap-around.

### BRIEF DESCRIPTION OF THE DRAWINGS

The invention is explained by way of an exemplary embodiment with the enclosed drawings. It shows:

FIG. 1—block diagram of an image processor unit connected to an image sensor;

FIG. 2—schematic current pixel and neighbouring pixels of a pixel array for an image;

FIG. 3—encoded data set for a current pixel X;

FIG. 4—encoded data set for a N-pixel group;

FIG. 5—signed look-up table for encoding gradient different bits with 5-bit signed code and 5-bit wrapping code.

### DETAILED DESCRIPTION OF THE INVENTION

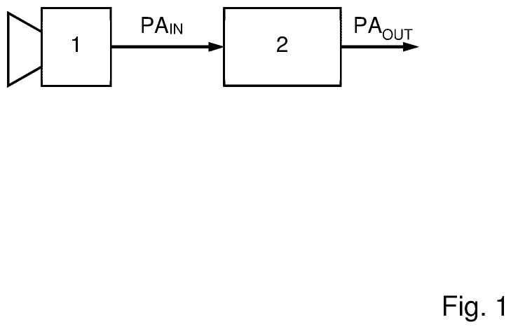

FIG. 1 illustrates a block diagram of an image processor unit 2 arranged for processing image data PA_{IN} of an image sensor 1 (e.g. at least one camera). Said image sensor 1 comprises a sensor area of a pixel matrix providing an image comprising matrix of pixel data PA_{IN} at the output of the image sensor 1, e.g. in form of a pixel data stream.

The image processor unit 2 can be designed in form of a microprocessor together with a computer program comprising instructions which, when the computer program is executed by the microprocessor, causes the processing unit to carry out the steps of determining gradient differences of a current pixel value of the incoming pixel data PA_{IN} and to encode the current pixel by replacing the current pixel by the gradient direction. The process can be performed for each current pixel of the pixel data PA_{IN} of a pixel data stream for an image, or of a selected current pixel of a group of N pixels.

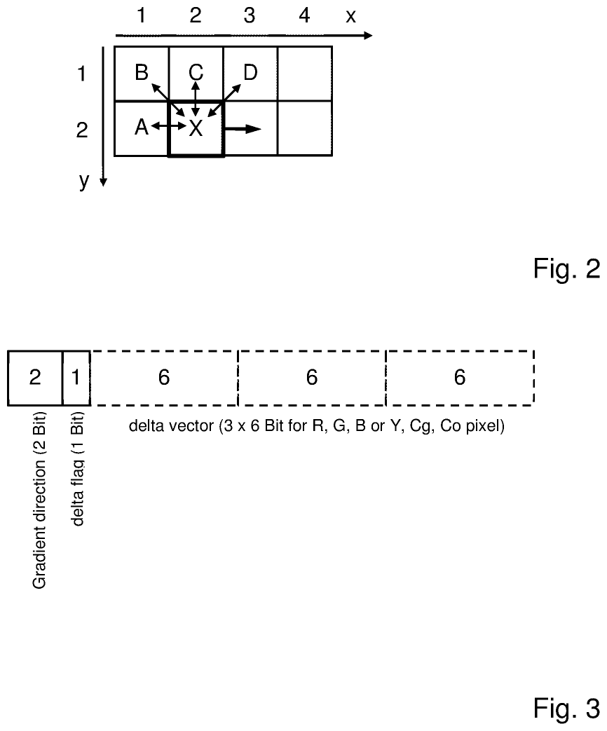

FIG. 2 illustrates a current pixel X and four neighbouring pixels A, B, C, D.

The current pixels X considered for the process are read in the order left-to-right and top-to-bottom as indicated by the arrow from the current pixel X to the neighbour pixels right side at X, Y position 3, 2. The reading starts at the first column, proceeds for each pixel in the line and shifts back to the following line at the position of the first column, once the current pixel reaches the last column of the respective line.

In the enclosed example, for each current pixel X a prediction direction is encoded e.g. as a 2-bit value. The four possible directions are “left” (which is indicated by the arrow between the left pixel A and the current pixel X), “top-left” (which is indicated by the arrow between the neighbouring pixel B and the current pixel X), “top” (which is indicated by the arrow between neighbouring pixel C and current pixel X) and “top-right” (which is indicated by the pixel D and the current pixel X). As shown, the image consists of a rectangular grid of pixels which can be triplets in, for example, either the RGB, YUV or YCrCg colour space with (typically) 8 bits per component. Thus, each of the pixels shown consists of a matrix of three pixel values for a respective colour RGB or YUV or any other suitable colour scheme.

Alternatively to the described embodiment, each of the pixels of a matrix can be formed as a singlet for a greyscaled image, or can consist of any higher order number according to the respective colour code scheme. The described example is based on three component code for each pixel.

The difference between the pixel value of the current pixel X and the respective neighbouring pixel A, B, C, D are determined for each colour respectively. The minimum gradient direction is determined from the values of the gradient differences to quantize the minimum gradient direction to the four directions left, top-left, top and top-right. This can be encoded e.g. by the 2-bit value 00 for left (A), 01 for top-left (B), 10 for top (C) and 11 for top-right (D) designating the gradient direction having the smallest difference value in the set of gradient differences determined for all these four directions.

Instead of keeping the value for the current pixel at the output pixel data, the current pixel can be replaced by the minimum gradient direction and an indicator (delta flag) indicating this replacement. Thus, the gradient direction is encoded in the pixel data stream. The receiver can use the sample of the neighbouring pixel data in the indicated gradient direction as a predictor for the current pixel, for which the pixel value is missing the data stream.

In case that the difference between the prediction and the current pixel X exceeds a certain threshold, the difference between the current pixel value and the neighbouring pixel value having the minimum gradient direction to the current pixel X can be encoded when it forms the delta vector. Thus, the current pixel value is replaced by the indicator of the gradient direction and the delta flag together with the three delta vectors for each colour RGB, YUV or the like.

While a data set for a current pixel would include e.g. 3×8 bit for the pixel value with three colours, the bit length can be reduced to three bits for the current pixel value, or together with the delta vector to 21 bits per current pixel.

The reduction of the bit length for the delta vector to 6 bits per pixel for example can be performed by using a piecewise linear approximation to a logarithmic curve.

This method allows an extremely simple implementation and provides a good colour quality. However, it tends to create “banding” artefacts in smooth gradients. The bitrate is variable and depends per pixel on the content. This is hard to control and needs rate control algorithms and is hard to implement in hardware. Thus, a lower bound of bitrate (e.g. 3 bpp) by the need to transmit 2 bits per gradient selector and one bit for the delta flag is beneficial.

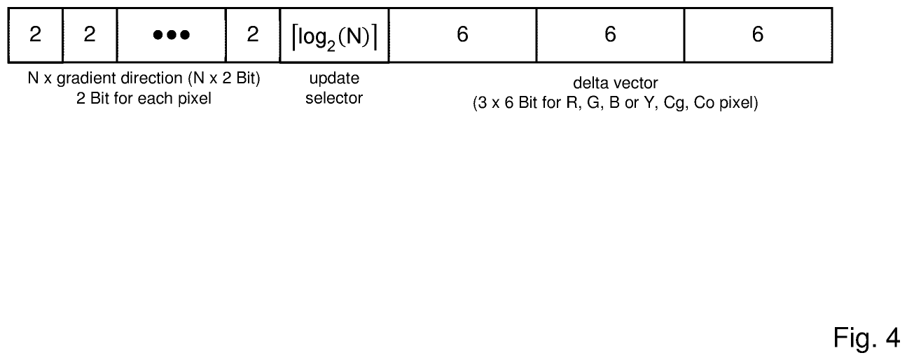

FIG. 4 presents the data structure for the output pixel data of a group of N pixels. The groups of pixels in an image do not overlap. The group size N can be selected as required and forms an encoding quality parameter.

For one selected current pixel X in a group, a delta or update is encoded. The index of that selected current pixel X within the group is provided as update selector comprising a bit length of log₂(N).

The delta, i.e. the difference between the pixel value for the current pixel for a respective colour RGB or YUV or YCgCo and the closest neighbouring pixel having the minimum gradient difference is added to the affected current pixel. Thus, the current pixel X is no longer a direct copy from the neighbour. Instead it has a delta vector applied to it before encoding/decoding continuous.

The delta vector itself is encoded as three Q-bit values, one for each colour component (e.g. RGB/YUV/YCgCo or the like). Q is an encoding quality parameter and can be different for each component.

For each of the N pixels of the group comprising N pixels the gradient direction is determined and provided in the delta set.

Preferably, the algorithm can easily be transformed into a fix-rate compressor providing a fixed number of bits per pixel. This can be achieved by encoding the delta for exactly one pixel in each group of N adjacent pixels. This reduces the overhead of the delta bit signalling from N (full bit) to [log₂(N)] index only.

A look-up table can be applied to determine the value that is added to the prediction from the delta code. Said look-up table can be constructed such that lower differences are quantized less than higher differences. The effect, that the addition may cause an integer overflow can be exploited to construct a more efficient code.

For example, with Q=6 for all components, the data set exemplified in FIG. 4 would be encoded for an N-pixel group.

As it can be seen, the number of pixel encoded for a group is constant for any chosen combination of the N and Q parameters resulting in a fixed number of bits per pixel, i.e. a perfectly constant bitrate.

This results in a pixel predictive encoding scheme, wherein the prediction direction is encoded explicitly. The prediction for one of the pixels in a group is modified using a delta code. The delta code uses a non-linear quantisation. The delta code could exploit for example two's component wrap-around. The selection of number N for the group size determines the bitrate as follows for the case of Q=6 bit and three component image colour codes (e.g. RGB/YUV/YCgCo):

| group size | bitrate |
|---|---|
| 2 pixels | 11.5 bpp |
| 3 pixels | 8.67 bpp |
| 4 pixels | 7.00 bpp |
| 5 pixels | 6.20 bpp |
| 6 pixels | 5.50 bpp |
| 7 pixels | 5.00 bpp |
| 8 pixels | 4.63 bpp |
| 9 pixels | 4.45 bpp |
| 10 pixels | 4.20 bpp |
| 11 pixels | 4.00 bpp |

This modification allows a fixed bitrate which is easily controllable. It solves image quality issues. Forced deltas in smooth gradients eliminate banding.

The processing for N pixels per group requires considerably more complex encoder implementation. There is a need to compute and compare all N encoding variants of each N-pixel group. The reason is that encoding a delta for current pixel X changes gradients and predictors for all further pixels. The encoder complexity depends on the bitrate and the group size. The lower the bitrate, the larger the groups and the higher the encoder complexity. With reasonable effort it is preferred to run the method in or below the target of 1:4 compression (6 bpp).

It is possible to select different group sizes for each colour component, e.g. RGB or YUV, different from each other.

A lower bound of bitrate e.g. 2 bpp can be reached for very large group sizes.

The constructions of the delta groups can be performed by encoding the gradient differences i.e. values. For example, wrapping codes exploit two's complement arithmetic as opposed to traditional signed codes.

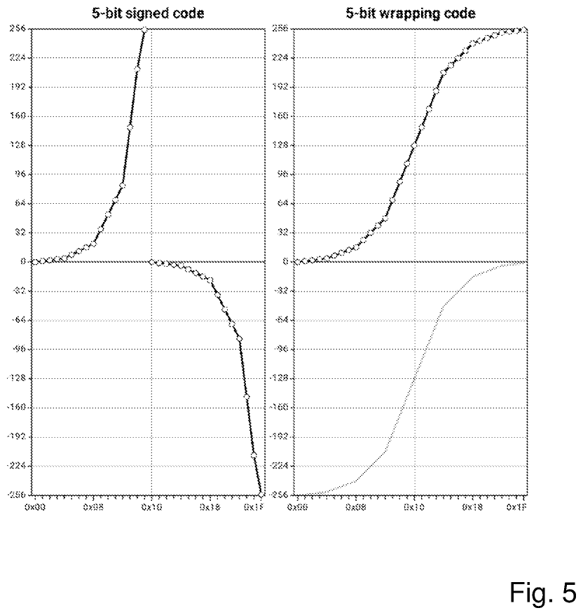

This is shown in FIG. 5 with exemplary 5-bit signed code for the signed +/−256 value range for 8-bit colour depth and a 5-bit wrapping code.

For pixel that receive a delta update the difference between the predicted (copied from neighbour) and actual (ground two's) pixel value can have a value range of −255 to +255 (assuming 8-bit colour depth). This needs to be encoded into Q bits. Obviously, this is always a lossy process if Q is less than 9. However, typical values of Q are around 3 to 6. The mapping look-up table LUT from the Q-bit delta code to the added/subtracted difference is of high importance to the image quality.

Since the differences between the predicted and actual pixels are typically small, the delta Look-Up-Table allocates more entries from smaller differences than it does for larger differences. For example, a useful 5-bit look-up table as shown in FIG. 5 could contain the values [0, 1, 2, 3, 4, 8, 12, 16, 20, 36, 52, 68, 84, 148, 212, 255] and their negative counterparts.

Such as “signed” look-up table is, however, the most effective grid presentation because depending on a pixel's value only part of the look-up table makes any sense. In the extremes, the predictor is 0 or 255, only the positive or negative half of the look-up table is used, i.e. half the space is wasted.

To remedy this, the look-up tables can be wrapped where the negative values are instead two's complement positive values as shown in FIG. 5 for the 5-bit wrapping code. When adding a decoded delta to the predicted pixel integer overflow and the resulting truncation of the most significant bit is explicitly used as a tool.

For example, the useful 3-bit “wrapping” look-up table could contain the values [0, 3, 6, 36, 128, 220, 250, 253]. Now, if the predicted value is 100 and the actual value is 97, the code for the difference of 253 would be encoded. When adding 100+253, the result is 353 which is not representable in 8 bits. By discarding the 8^{th} bit, the remainder is 97 which is exactly the target value. For the extreme cases of predicted values 0 and 255 the “wrapping” look-up tables no longer waste half the code space. There certainly are needlessly precise presentations for the pixel values near the opposite end of the value range, but no unreachable values by definition.

A “full” highest quality encoder needs to try all possible delta pixel locations in a group, and picks encoding that shows the least visual difference to the original image. This mode has by far the best quality but it is quite slow, especially with large group sizes. Complexity for each pixel is O(N) with group size. A simple encoder implementation that avoids multiple encoding attempts uses heuristics to select the delta pixel index upfront generating a possibility sub-optimal decision (and hence non-optimal image quality) but in much less time. Complexity per pixel is constant, i.e. O(1).

An even simpler encoder not only decides the delta pixel index upfront, but also the prediction direction. This results in further reduction in quality for another small gain in speed.

The decoder is not affected by this. It can almost decode each pixel individually without look-ahead.

The encoding of the delta codes can be performed by any suitable method. For example, any two's compliment co-element look-up tables with values between −255 to +255 (“signed”) or 0 to 255 (“wrapping”) is possible, or for lower higher bit numbers respective values.

The method can be performed on any number of colour components, e.g. for one colour component for monochrome images or more than three colour components for multiple spectral images.

The algorithm can be converted into a variable-rate encoding scheme by allowing the update selector to have a value of N, i.e. an invalid index that does not refer to any pixel in the group, and not encode a delta in that case. The encoder can then chose to not send a delta at all in uniform regions of the image.

The method requires a low computational complexity, especially in the decoder. Only one line buffer is required for encoding and decoding. Lossy compression preserves structure and object contours. No blocking or ringing artefacts occurs. The prediction direction that is encoded directly in the delta stream is a coarsely quantized structure tensor and can be used as the input for subsequent image processing operation set to require that kind of information.

Due to the fact that only one pixel in a group can have a delta, a very specific pattern emerges for very noisy content, which irregularly shape clusters of pixels that have the exact same colour.

1. A method for processing of image data, wherein an image comprises a matrix of pixels, the method comprising:
a) determining differences between a pixel value of a current pixel and a pixel value of a respective adjacent pixel in a number of gradient directions; and
b) encoding the current pixel by replacing the current pixel by the gradient direction having the minimum gradient difference determined in step a) for the current pixel.

2. The method according to claim 1, further comprising including a delta flag to the gradient direction used in step b) for encoding the current pixel in order to indicate, that the pixel data is a predictor for the current pixel.

3. The method according to claim 1, wherein encoding the current pixel by replacing the current pixel by the gradient direction having the minimum gradient difference determined in step a) and the encoded values for the gradient differences determined in step a) for the current pixel, in case that the minimum gradient difference for the current pixel exceeds a threshold value.

4. The method according to claim 1, comprising performing the method for each pixel in the matrix of an image considered as respective current pixel.

5. The method according to claim 1, comprising performing the method by consideration of exactly one pixel in a group of a number N of adjacent pixels as current pixel.

6. The method according to claim 1, comprising encoding the values for the gradient differences by assigning the values to predetermined codes of a code table.

7. The method according to claim 6, comprising wrapping the code table by use of the two's complement positive values instead of negative values.

8. An image processor unit for processing image data of an image sensor, said image sensor comprising a sensor area of a pixel matrix providing an image having a matrix of pixel data, the image processor unit configured to
a) determine differences between a pixel value of a current pixel and a pixel value of a respective adjacent pixel and a number of gradient directions; and
b) encode the current pixel by replacing the current pixel by the gradient direction having the minimum gradient difference determined in step a) for the current pixel.

9. The image processor unit according to claim 8, wherein the image processor unit is configured to include a delta flag to the gradient direction used in step b) for encoding the current pixel in order to indicate, that the pixel data is a predictor for the current pixel.

10. A non-transitory computer-readable medium comprising computer executable instructions which, when the instructions are executed by a processing unit, cause the processing unit to carry out the steps of the method of claim 1.

11. The image processor unit according to claim 8, wherein the image processor unit is configured to encode the current pixel by replacing the current pixel by the gradient direction having the minimum gradient difference determined in step a) and the encoded values for the gradient differences determined in step a) for the current pixel, in case that the minimum gradient difference for the current pixel exceeds a threshold value.

12. The image processor unit according to claim 8, wherein the image processing unit is configured to determine and encode functions for each pixel in the matrix of an image considered as respective current pixel.

13. The image processor unit according to claim 8, wherein the image processing unit is configured to consider exactly one pixel in a group of a number N of adjacent pixels as current pixel.

14. The image processor unit according to claim 8, wherein the image processing unit is configured to encode the values for the gradient differences by assigning the values to predetermined codes of a code table.
